(19) United States
(12) Patent Application Publication
(10) Pub. No.: US 2003/0079973 A1
(43) Pub. Date: May 1, 2003

(54) Wearable switch method and apparatus for people with limited mobility

(76) Inventors: Ying Sun, Wakefield, RI (US); Marc A. Duquette, Harrisville, RI (US); Allan T. Ducharme, Pascoag, RI (US); Steven E. Kanor, Hastings-on-Hudson, NY (US)

Correspondence Address: Ying Sun, 210 Table Rock Road, Wakefield, RI, 02879, US

(21) Appl. No.: 10/282,844

(22) Filed: Oct. 29, 2002

Related U.S. Application Data
(60) Provisional application No. 60/336,239, filed on Oct. 31, 2001.

(51) Int. Cl. H01H 9/00

(52) U.S. Cl. 200/52 R

(57) ABSTRACT

A wearable switch apparatus for a person having a digit which comprises a housing, a switch disposed in the housing, a member secured to the housing and adapted to receive the digit and an adjustable lever in communication with the switch. The lever is configured and arranged based on the mobility of the digit to form a spaced relationship between the digit and the lever thereby allowing the digit to contact the lever and activate the switch. The apparatus is supported on the digit.

### PRIORITY DATA

This application claims the benefit of U.S. Provisional Application No. 60/336,239, filed Oct. 31, 2001, and hereby incorporated by reference.

### BACKGROUND OF THE INVENTION

A study from the National Institute on Disability and Rehabilitation Research showed that in 1996 24 million people (9.6%) in the United Sates had severe disabilities and another 25 million people (9.9%) had minor disabilities. During the past century (20^{th} century) the life expectancy in the United States increased from 47 years to 77 years. As our society is aging, assistive technology becomes increasingly important for taking care of the elderly, improving their independence and quality of life.

Switch technology for people with disabilities and the elderly has been an important area of assistive technology. These people may have limited mobility because of conditions such as quadriplegia, paraplegia, cerebral palsy, severe arthritis, spinal cord injury, head injury, and other neuromuscular disorders. In many cases a simple switch is the only mechanism for these people to communicate, move, and control their environments. Factors such as switch travel, activation/position feedback, spacing, and direction of activation are important in the design of consumer product controls (Rahman M M, Sprigle S; “Physical accessibility guidelines of consumer product controls” 1997; pp. 3-14; Assistive Technology, vol. 9, no. 1).

A need exists for a wearable switch intended for a person who has some but limited finger mobility. For example, a quadriplegic person may still be able to intentionally move one of his or her fingers only slightly. This slight voluntary movement may be sufficient to operate a switch. However, the switch must be in an exact spatial position relative to the mobile finger. It is important to identify a switch sensitive enough to be activated by the mobile finger. But more importantly, an effective mechanism must be identified to hold the switch in a proper position and spatial orientation with respect to the mobile finger. Attempts to solve this problem have included apparatuses wherein the switch is mounted to a bed railing, a wheelchair, or a nearby wall. In some instances, adjustable mechanical arms are needed to position the switch toward the mobile finger. Mounting and positioning of the switch is problematic. If the relative position between the switch and the mobile finger is changed, the person may have difficulty to operate the switch or may not be able to reach the switch at all. The person using the switch usually does not have sufficient arm and body mobility to reposition the finger when the switch is out of reach.

This invention addresses the problem of mounting and positioning switches for people with limited finger mobility to control electronic devices.

### SUMMARY OF THE INVENTION

The invention includes the attachment of a switch having an activation mechanism to the hand of the disabled user. In one aspect of the invention, the switch can be worn on the fingers and the relative position between the switch and the mobile finger that controls the switch can be precisely set and easily maintained.

By wearing the switch on a finger or multiple fingers, the switch is firmly attached to the hand. The finger or fingers wearing the switch provide a stable support for the switch even if the fingers may be non-mobile. The switch is attached to one or two wearing rings. The rings can be comprised of rigid or flexible metal or flexible rings formed from hook and loop fasteners, such as VELCRO hook and loop straps. In one embodiment of the invention the rings can be adjusted based upon the size of the user's digits. The activation mechanism for the switch, e.g., a lever, can be positioned and oriented toward the mobile finger. In one aspect of the invention, the configuration of the wearable switch is determined by the conditions of finger and/or thumb mobility particular to the user. Depending on which mobile finger and/or thumb is available and its direction of movement, the switch can be properly positioned by choosing the switch attachment configuration and wearing position and by adjusting the activation mechanism. The relative position between the activation mechanism and the mobile finger can therefore be properly set and maintained.

In one aspect, the invention includes a wearable switch apparatus for a person having a digit which comprises a housing, a switch secured to the housing, a member secured to the housing and adapted to receive the digit and an adjustable lever in communication with the switch. The lever is configured and arranged based on the mobility of the digit to form a spaced relationship between the digit and the lever thereby allowing the digit to contact the lever to activate the switch. The apparatus is supported on the digit.

In another aspect of the invention, the switch is disposed in the housing and the member is integral with the housing and comprises a first ring in registration with a second ring.

In yet another aspect of the invention, the lever has a first end and a second end and further comprises a knob secured to the second end. The lever can be comprised of a malleable metal.

The invention further includes, a wearable switch apparatus for a person having a first, a second and a third digit which comprises a housing, a switch secured to the housing, a first member secured to the housing and adapted to receive the first digit, a second member secured to the housing and adapted to receive the second digit and an adjustable lever in communication with the switch. The lever is configured and arranged based on the mobility of the third digit to form a spaced relationship between the third digit and the lever thereby allowing the third digit to contact the lever and activate the switch. The apparatus is supported on the first and second digits.

In one aspect of the invention, the first member comprises a first ring and the second member comprises a second ring. The first and second rings can be rigid or flexible and are contiguous.

In yet another aspect, the invention includes a method for operating a wearable switch by a person having a digit which comprises supporting a housing having a switch and a member adapted to receive the digit on the digit, positioning an actuator in communication with the switch in a spaced relationship with the digit such that when the digit moves and contacts the actuator the switch is activated and contacting the actuator to activate the switch.

The invention further includes a wearable switch apparatus for a person having a digit which comprises a housing, a switch secured to the housing, a member secured to the housing and adapted to receive the digit and an actuator in communication with said switch. The actuator is configured and arranged based on the mobility of the digit to form a spaced relationship between the digit and the actuator thereby allowing the digit to control the actuator and activate the switch. The apparatus is supported on the digit. The actuator can comprise a lever, a button, a pressure sensor or an infrared (IR) sensor.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a perspective view of an embodiment of the invention;

FIGS. 2A-2C are perspective views of an alternative embodiment of the embodiment illustrated in FIG. 1;

FIGS. 3A-3E are perspective views of an alternative embodiment of the invention;

FIGS. 4A-4C are perspective views of alternative embodiments of the embodiment illustrated in FIG. 3A;

FIG. 5 is an alternative embodiment of the embodiment illustrated in FIG. 4B;

FIG. 6 is an alternative embodiment of the embodiment illustrated in FIG. 5; and

FIG. 7 is a yet another alternative embodiment of the invention.

### DETAILED DESCRIPTION OF THE INVENTION

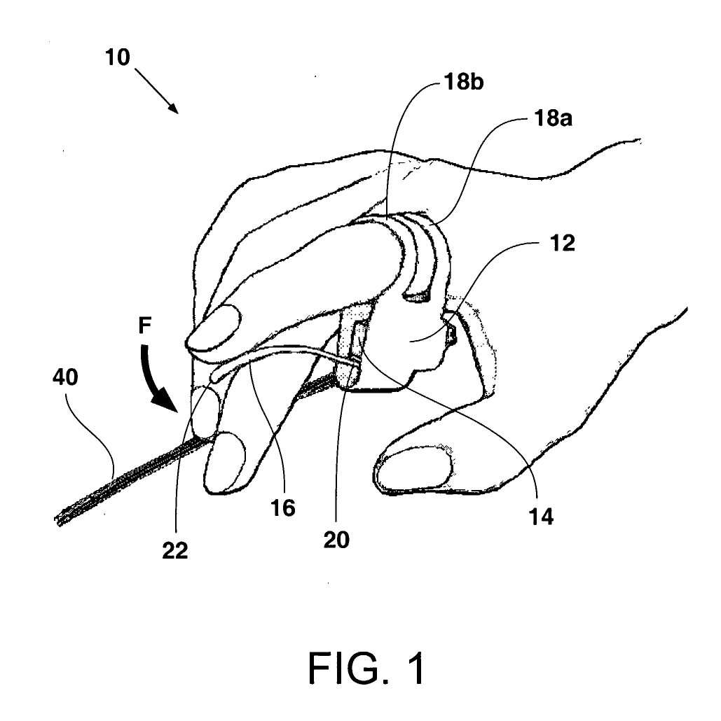

Referring to FIG. 1, a wearable switch apparatus 10 is generally shown. A switch 14 is disposed in a housing 12. A ring 18a in registration with a ring 18b are integral with the housing 12 and are adapted to receive a digit of the user of the switch. The digit supports the apparatus 10 when the digit of the user is received in the rings 18a and 18b. A lever 16 communicates with the switch 14. When the digit of the user of the switch 14 applies force to the lever 16 in the direction as indicated by arrow F the switch 14 is activated. That is, when enough force is applied to the lever 16, the switch changes state and provides a Boolean signal indicative thereof. The switch 14 is preferably a momentary contact switch. The switch springs back to its initial state when the force applied to the lever is removed. The lever 16 is adjustable and can be positioned based on the range of motion of the digit to form a spaced relationship between the digit and the lever 16 thereby allowing the digit to apply force to the lever 16 and activate the switch 14.

The digit can be a mobile index finger of the user that has mobility toward the palm side of the hand. The index finger is received in the rings 18a and 18b thereby allowing the user to wear the entire switch apparatus on the base of the index finder. The lever 16 has a first end 20 that is attached to the switch 14 and a second end 22 that is positioned at the tip of the mobile index finger. The switch 16 closes or opens a circuit of an electronic device (not shown) via an electrical wire 40 containing two conductors (not shown). Suitable switches can include the subminiature snap-action hinge-lever switches, such as the D2F-L series manufactured by OMRON, website www.omron.com. The arrow F indicates a downward movement of the index finger to activate the switch 14. The index finger moves slightly toward the palm side, depresses the lever 16, and thereby activates the switch 14. The lever 16 can be made of a bendable material such as for example metals and plastics. Suitable metals can include iron, stainless steel, aluminum, copper, and alloys. The lever 16 can be adjusted, e.g., bent, with a hand held tool, e.g., a pair of pliers, or hand force to a position close to the tip of the index finger such that a small movement of the index finger is sufficient to activate the switch 14.

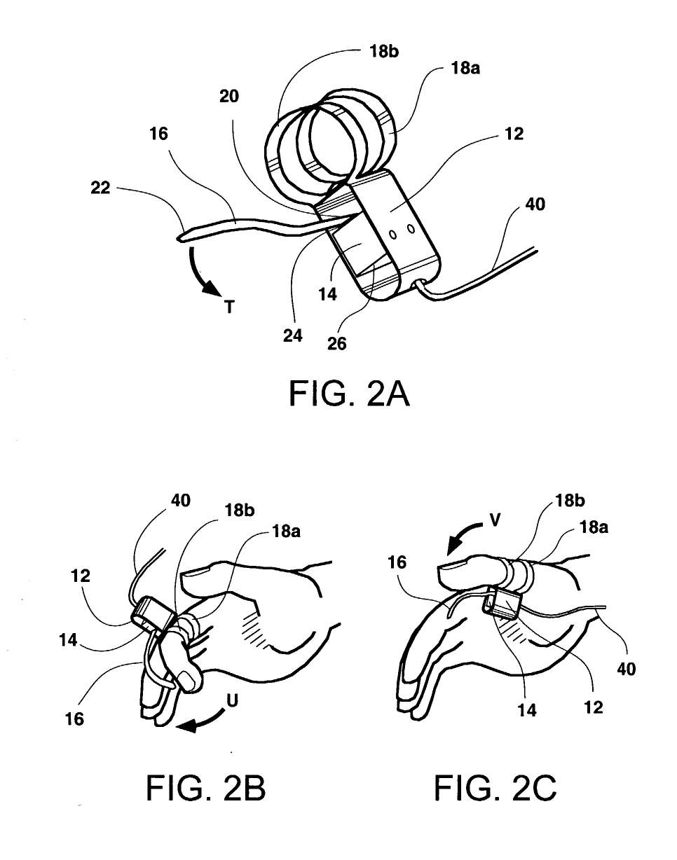

Referring to FIGS. 2A-2C, an alternative embodiment of FIG. 1 is shown. The apparatus of FIG. 1 is modified with like components having the same numbers. The switch 14 has a top portion 24 and bottom portion 26. The first end 20 is attached to the top portion 24 of the switch 16. The index finger of the user is received in the rings 18a and 18b. In this embodiment, the wearable switch apparatus 10 is worn on the mobile finger itself. For stability reasons the two rings 18a and 18b are used to wear the switch at the base of the finger. Referring to FIG. 2A, when an index finger is received in the rings 18a and 18b, the tip of the index finger can activate the switch 16 by depressing the lever 14 in the direction as indicated by arrow T.

Referring to FIG. 2B, the index finger of the user is received in the rings 18a and 18b and the housing 12 is positioned on the backside of the hand. An upward movement of the index finger as indicated by arrow U moves the lever 16 and activates the switch 14.

Referring to FIG. 2C, the thumb of the user is received in the rings 18a and 18b and the housing is positioned on the underside of the thumb of the user. A downward movement of the thumb of the user as indicated by arrow V moves the lever 16 and activates the switch 14, which provides a Boolean signal in the line 40 indicative of whether or not sufficient triggering force has been applied to the lever 16.

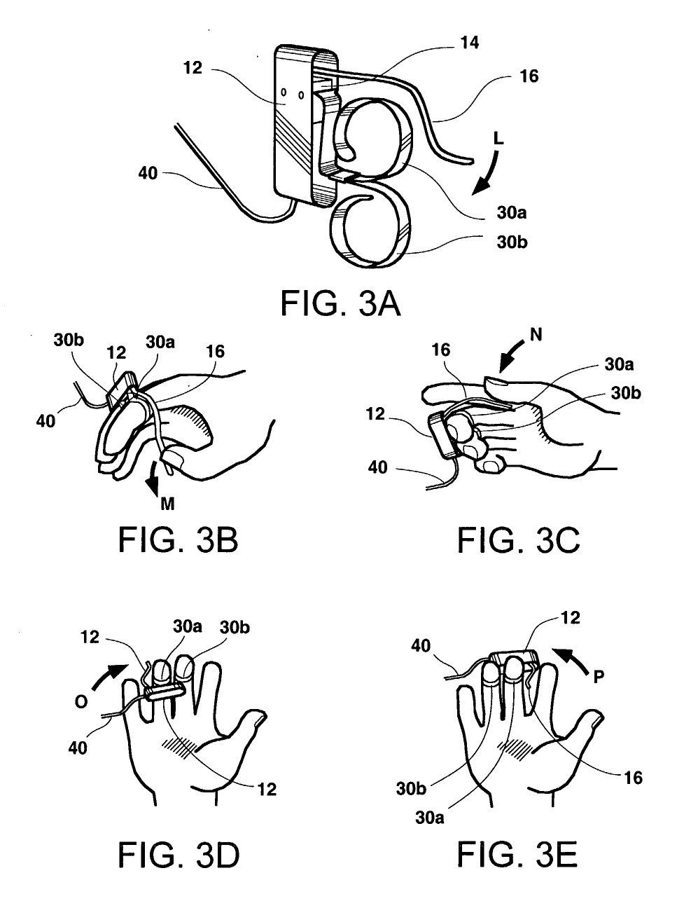

Referring to FIG. 3A, an alternative embodiment of the invention is shown. The apparatus of FIG. 1 is modified with like components having the same numbers. The switch 14 is disposed within the housing 12. Secured to the housing 12 is a first ring 30a and second ring 30b. A lever 16 for activating the switch 14 extends outside the housing 12. The switch 14 closes or opens a circuit of an electronic device (not shown) via an electrical wire 40. The rings 30a and 30b are adapted to receive a first and second digit of the user respectively. The lever 16 is adjustable and can be positioned based on the range of motion of a third digit of the user to form a spaced relationship between the third digit and the lever 16 thereby allowing the digit to contact the lever 16 and activate the switch 14. Application of a force toward the rings 30a and 30b as indicated by arrow L will activate the switch 14.

Referring to FIGS. 3B-3E, four wearing positions of the apparatus are shown. Application of force as indicated by arrows M, N, O and P will activate the switch 14 (not shown). Referring to FIG. 3B, the index and middle fingers of the user are received in the rings 30a and 30b. The housing 12 is positioned on the backside of the hand. A downward movement of the thumb as indicated by arrow M activates the switch.

Referring to FIG. 3C, the ring and middle fingers of the user are received in the rings 30a and 30b and the housing 12 is positioned on the palm side of the hand. A downward movement of the thumb as indicated by arrow N depresses the lever 16 and activates the switch 14 (not shown).

Referring to FIG. 3D, the middle and ring fingers of the user are received in the rings 30a and 30b and the housing 12 is positioned on the palm side of the user's hand. A lateral movement of the user's pinkie as indicated by arrow O depresses the lever 16 and activates the switch 14 (not shown).

Referring to FIG. 3E, the middle and ring fingers of the user are received in the rings 30a and 30b and the housing 12 is positioned on the backside of the hand. A lateral movement of the index finger toward the middle finger as indicated by arrow P depresses the lever 16 and activates the switch 14 (not shown).

As illustrated in FIGS. 3B-3E, the lever 16 can be positioned based on the range of motion of the third digit of the user thereby allowing the user of the apparatus to depress the lever and activate the switch. In each case, the apparatus is worn by the user. The most effective way of wearing the switch is determined by which mobile finger is available and its direction of movement.

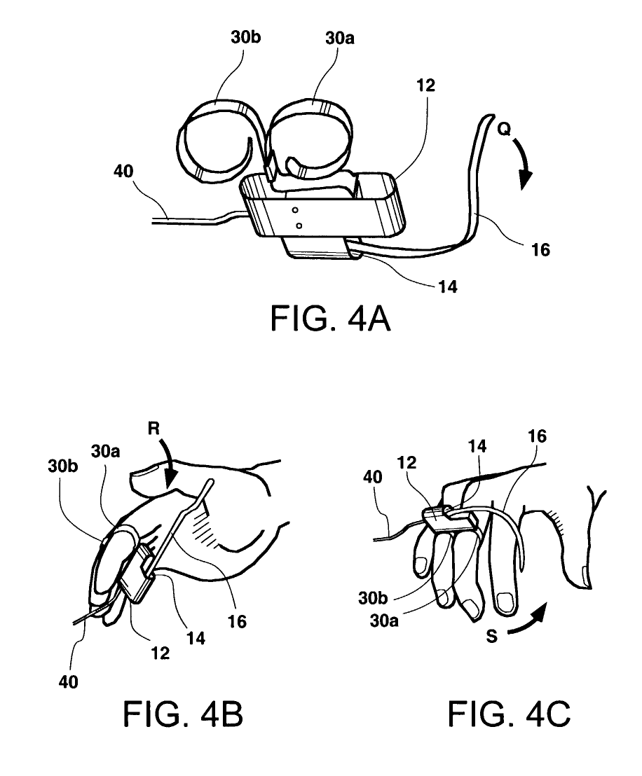

Referring to FIG. 4A, yet another alternative embodiment of the apparatus is show. The apparatus of FIG. 3A is modified with like components having the same numbers. The switch 14 extends outwardly from the housing 12. Application of a force on the lever 16 in a direction away from the rings 30a and 30b as indicated by arrow Q will activate the switch 14, whereas the direction of activation for the switch in FIG. 3A as indicated by arrow L is toward the rings 30a and 30b.

Referring to FIG. 4B, the index and middle fingers of the user are received in the rings 30a and 30b and the housing 12 is positioned on the palm side of the hand. A downward movement of the thumb as indicated by arrow R depresses the lever 16 and activates the switch 14.

Referring to FIG. 4C, the middle and ring fingers are received in the rings 30a and 30b and the housing 12 is positioned on the backside of the hand. A lateral movement of the index finger toward the thumb as indicated by arrow S depresses the lever 16 and activates the switch 14.

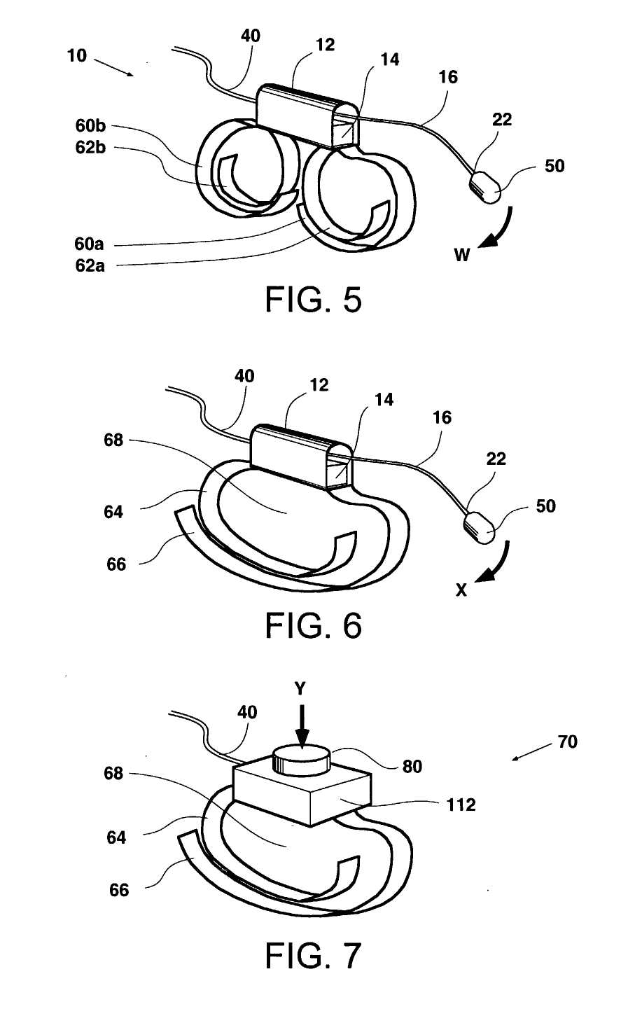

Referring to FIG. 5, the apparatus 10 is shown with like components as illustrated in FIG. 3A. The rigid rings 30a and 30b in FIG. 3A are replaced by four VELCRO strips 60a, 62a, 60b and 62b in FIG. 5. A knob 50 is attached to the second end 22. In this embodiment, the lever 16 is a spring wire and the knob 50 is a rubber knob that helps absorb the mechanical vibrations of the switching operation. The switch 14 is activated by applying a force on the lever 16 in the direction as indicated by arrow W.

Referring to FIG. 6, the four VELCRO strips 60a, 62a, 60b and 62b are replaced with a first VELCRO strip 64 and a second VELCRO strip 66. The first strip 64 is fastened to the second strip 66 to form single loop 68. A digit or digits of the user can then be inserted through the loop 68. The switch 14 is activated by applying a force on the lever 16 in the direction as indicated by arrow X.

Referring to FIG. 7, a wearable switch apparatus 70 is generally shown. The apparatus comprises a housing 112 having a switch disposed therein. An actuator 80 is positioned on the housing 112 and communicates with the switch. Adjustable VELCRO straps 64 and 66 can be fastened one to other to form a loop 68. The loop 68 is adapted to receive a digit or digits of the user. The actuator 80 can be a push button switch, a pressure sensor that detects minute movements of the digits of the user or an IR sensor that senses the heat of a digit of the user. The electronics and mechanics of such actuators 80 and switches need not be described in detail as such devices and their components are well known in the art. In operation, a first digit of the user is received in the loop 68 and the actuator 80 is positioned to allow a second mobile digit of the user to control the actuator to activate the switch. For example, the index finger of the user can be inserted through the loop and the actuator 80 can be positioned based on the mobility of the user's thumb such that the user can control the actuator 80, e.g., a button, by moving the thumb towards the actuator 80 and contacting the actuator 80 in the direction as indicated by arrow Y. If the actuator 80 is a motion sensor, the switch can be operated by inserting a finger or thumb through the loop and moving the finger or thumb in a manner to activate the motion sensor thereby operating the switch. If the actuator 80 is an IR sensor, the switch can be operated by inserting a first digit of the user through the loop and positioning the actuator 80 in manner based on the mobility of a second digit of the user whereby the second digit of the user moves toward the IR sensor such that the heat from the second digit activates the IR sensor.

Although the present invention has been shown and described with respect to several preferred embodiments thereof, various changes, omissions and additions to the form and detail thereof, may be made therein, without departing from the spirit and scope of the invention.

What is claimed is:

1. A wearable switch apparatus for a person having a digit which comprises:
a housing;
a switch secured to the housing;
a member secured to said housing and adapted to receive the digit; and
an adjustable lever in communication with said switch, said lever being configured and arranged based on the range of motion of the digit to form a spaced relationship between said lever and the digit thereby allowing the digit to contact the lever and activate the switch, the apparatus being supported on the digit.

2. The apparatus of claim 1 wherein said switch is disposed in said housing and said member is integral with said housing and comprises a first ring in registration with a second ring.

3. The apparatus of claim 2 wherein said lever has a first end and a second end and which further comprises a knob secured to said second end.

4. The apparatus of claim 3 wherein said lever is comprised of a malleable metal.

5. A wearable switch apparatus for a person having a first, a second and a third digit which comprises:
a housing;
a switch secured in said housing;
a first member secured to said housing and adapted to receive the first digit;
a second member secured to said housing and adapted to receive the second digit; and
an adjustable lever in communication with said switch, said lever being configured and arranged based upon the range of motion of the third digit to form a spaced relationship between said lever and the third digit thereby allowing the third digit to contact the lever and activate the switch, the apparatus being supported on the first and second digits.

6. The apparatus of claim 5 wherein the first member comprises a first ring and the second member comprises a second ring, the first and second rings being contiguous.

7. The apparatus of claim 6 wherein the lever is comprised of a malleable metal.

8. The apparatus of claim 7 wherein the first and second rings are rigid.

9. The apparatus of claim 8 wherein the first and second rings are flexible.

10. A method for operating a wearable switch by a person having a digit comprising:
supporting a housing having a switch and a member adapted to receive the digit on the digit;
positioning an actuator in communication with said switch in a spaced relationship with the digit such that when the digit moves and contacts said actuator the switch is activated; and
contacting said actuator to activate the switch.

11. A wearable switch apparatus for a person having a first and a second digit which comprises:
a housing;
a switch secured to said housing;
a member secured to said housing and adapted to receive the first digit; and
an actuator in communication with said switch, said actuator being configured and arranged based upon the mobility of the second digit to form a spaced relationship between the actuator and the digit thereby allowing the second digit to control the actuator and activate the switch, the being supported on the first digit.

12. The apparatus of claim 11 wherein said actuator is a button.

13. The apparatus of claim 11 wherein said actuator is a pressure sensor.

14. The apparatus of claim 11 wherein said actuator is an IR sensor.

15. The apparatus of claim 11 wherein said actuator is a lever.
